(19) United States
(12) Patent Application Publication
(10) Pub. No.: US 2025/0097038 A1
(43) Pub. Date: Mar. 20, 2025

(54) Full-Duplex Password-less Authentication

(71) Applicant: Identité, Inc., Clearwater, FL (US)

(72) Inventors: John P. Hertrich, Clearwater, FL (US); Mohammad Mozdurani Shiraz, Minsk (BY)

(73) Assignee: Identité, Inc., Clearwater, FL (US)

(21) Appl. No.: 18/967,717

(22) Filed: Dec. 4, 2024

Related U.S. Application Data
(63) Continuation-in-part of application No. 17/557,091, filed on Dec. 21, 2021, now Pat. No. 12,177,210.
Application No. 17/557,091 is a continuation of application No. 17/094,845, filed on Nov. 11, 2020, now Pat. No. 11,245,526.
(60) Provisional application No. 62/943,837, filed on Dec. 5, 2019.

(51) Int. Cl. H04L 9/32; H04L 9/30

(52) U.S. Cl. CPC H04L 9/3213; H04L 9/3073; H04L 9/3228; H04L 9/3268; H04L 9/3271

(57) ABSTRACT

A browser-based full-duplex password-less authentication system provides secure access to third-party services without requiring password entry. Upon attempting to access a service, an access server generates a visual representation and at the browser, a one-time password is converted into a second visual representation, both have an image and alphanumeric characters and are displayed simultaneously on a display of a client device. The user compares the first and second visual representations and confirms that they match. Security is maintained through Transport Layer Security (TLS) with specific cipher suite requirements, digital certificates, and protection against man-in-the-middle attacks. This approach eliminates password management burdens while providing strong security through visual verification and cryptographic protections, all within the user's browser environment.

### CROSS-REFERENCE TO RELATED APPLICATION

This application is a continuation-in-part of U.S. application Ser. No. 17/557,091 filed on Dec. 21, 2021, which is a continuation-in-part of U.S. application Ser. No. 17/094,845 filed on Nov. 11, 2020, which claims the benefit of U.S. provisional application No. 62/943,837 filed on Dec. 5, 2019, the disclosure of each is incorporated by reference.

### FIELD OF THE INVENTION

This invention relates to the field of online security and more particularly to a system for full-duplex password-less authentication that is resilient to cyber intrusions.

### BACKGROUND OF THE INVENTION

Computer security is difficult with many security risks. Current systems designed to reduce security risks result in added access difficulties and burdens of passwords for users and organizations. These difficulties and burdens have led to a rapid growth of password substitution methods. Some of these methods are secure but slow and difficult to operate with and others sacrifice security for user convenience. Hardware tokens are one secure method of authentication, but are not scalable, are expensive, are easy to lose, and are not cloud based and still require passwords and the maintenance of passwords. Legacy authentication with passwords requires a second factor authentication such as push notification, an SMS message, or a phone call, slowing down the authentication process.

There are many social engineering attacks reported every week. Social engineering attacks, describe a broad range of malicious tricks used by hackers to gain a victim's trust. The methods used are becoming increasingly more elaborate and sophisticated. To prevent social engineering and hacking attempts, users need to have the tools to protect their online digital world. Authentication at login is the first gateway to the users' digital world. This gateway must be as strong as possible to protect a user's valuable assets from attack.

Here is a daunting array of attacks currently being used:
Man-in-the-Middle-Phishing-Pharming-Malware, Ransomware-Password Guessing-OTP Interception-Wiretapping-SIM Cloning-Cross Site Scripting-Parallel Session Attack-Server Side Data Breaking-Shoulder Surfing-Reuse password attack-Theft of Authenticator-Channel Vulnerabilities-Brute Force & Dictionary-Replay-Stored Browser Passwords-Sniffing-Smartcard Loss or Cloning Attack. While this list is extensive, they all rely on some basic weakness to trick either the user or the service provider. Now we shall examine how at least one of these attacks function.

A man-in-the-middle attack is carried out by hackers who insert themselves in the communications path. Being in the communication path between the different parties gains access to all the information sent to and from both the parties. The hacker can stop the users from sending and receiving data, copy and save the data, or might even divert and redirect the messages. The main objective of man-in-the-middle attack (MiM) is to eavesdrop on the users' conversation. They mask their presence, making everything appear normal. The parties are unaware there is a third person involved in the communication. A man-in-the-middle attack allows the hacker to steal user login credentials, financial details, and credit card numbers and so on.

Weak and not properly encrypted connections between the user devices and a portal that provides services allows the man-in-the-middle to intercept data while weak encrypted messages allow the man-in-the-middle to extract the important information from those messages including, for example, usernames, passwords, credit card numbers, pin codes and many more important personal information.

What is needed is a system that will provide user authentication for using a service of a portal without requiring the user to remember/enter a password.

### SUMMARY OF THE INVENTION

The full-duplex password-less authentication both maximizes security and simplifies the authentication process for the end user as well as the service provider. The full-duplex password-less authentication is highly secure and avoids the use of passwords, which can be lost or stolen, and are often written on paper so the user can remember their complicated passwords.

User authentication of the prior art is typically achieved by requiring a user to enter a password to verify the user's identity. Requiring a password for user authentication is often inefficient and open to attack. Passwords are forgotten, hacked, stolen, misplaced, reused across several systems, etc., and are often a major security risk. Moreover, such authentication systems rely solely on authenticating the user for the service, as the identity and authentication of the service is not provided for the user. Embodiments of the full-duplex password-less authentication service described will reduce reliance on passwords and increase overall security for the user and the service by providing a mechanism to conduct a password-less mutual authentication for both the service and for the user.

The full-duplex password-less authentication service begins by generating a one-time password for each user, enabling users to verify the authenticity of the service they are accessing. The authentication process starts by displaying a one-time password on the client device's web portal as a combination of a picture and an alphanumeric code. This combination is generated by the authentication server and displayed directly on the client device, ensuring the user can visually confirm it as the first step in the authentication process.

The second stage of verification takes place entirely on the same client device. Rather than sending the second verification image and code to a separate mobile device, as in previous versions, the authentication server now sends this second picture and code to the client device via a secure web-push notification. This web-push appears as a pop-up notification within the user's browser on the client device, displaying the same picture and alphanumeric code for the user to compare with the initial display on the web portal.

The user then completes the authentication by visually confirming the match between the two codes and images displayed within the client device. Once the user confirms that the displayed codes and images match, they input their approval directly within the client device. This triggers the client device to send an authentication acknowledgment to the authentication server. In turn, the authentication server confirms the transaction by issuing an access token to the third-party server, thereby granting the client device access to the service.

This password-less authentication service verifies both the user's authenticity and the service's authenticity by using a dual-stage visual confirmation on a single device. Through the use of public key cryptography, secure keys are generated and exchanged between the client device, authentication server, and third-party server, ensuring that the process remains cryptographically secure. This full-duplex password-less authentication system is adaptable to any service requiring enhanced authentication, eliminating the need for mobile device dependencies while preserving a high level of security.

In this embodiment, user registration is performed through an embedded deep link presented on the web portal of the third-party service. The user initiates the registration process simply by clicking on this link, which completes registration by securely setting up a unique cryptographic key pair associated with the user's client device. The authentication server generates this key pair, storing the public key on the authentication server for future secure interactions with the third-party service, all without requiring an external device.

For authentication, the full-duplex password-less system leverages web-push notifications sent directly to the user's browser, removing the need for any mobile device. When the user attempts to access the third-party service, the authentication server generates a one-time password, which is transformed into a picture and alphanumeric code that is then sent via a web push notification to the user's browser. The picture and code are displayed on the user's browser, where they verify the authentication sequence through a single visual confirmation on the same device, without any cross-device comparison. Upon confirming the match, the user inputs a single acknowledgment, signaling approval of the authentication request.

This streamlined, device-independent authentication system applies to any service currently reliant on passwords or secondary authentication steps, enhancing security while improving the user experience by removing mobile device dependence.

In one embodiment, a computer-implemented method for password-less, full-duplex authentication of a user accessing a third-party server without requiring a password or mobile device is disclosed. This method includes pre-registering the user's client device with the authentication server by embedding a deep link on the web portal where the user seeks access. When the user clicks the link, the authentication server generates and stores a unique cryptographic key pair, sending the public key securely to the authentication server, where it is stored for future connections.

When the user initiates a session on the client device, the client device sends an access request including user identification to the third-party server. The third-party server establishes a secure connection with the authentication server, validated by the authentication server through digital certificates. An authentication request, including the user identification, is sent to the authentication server, which responds by generating a one-time password and a corresponding picture and alphanumeric code. The picture and code are sent directly to the client device through a web-push notification and are displayed on the client's browser.

The user visually confirms the authentication by comparing the picture and code displayed in their browser and submits an input acknowledging the match. This triggers the client device to send an authentication acknowledgment token to the authentication server, which then relays an access token to the third-party server. Upon receiving the access token, the third-party server grants access to the client device, thereby completing a secure and password-less authentication process.

### BRIEF DESCRIPTION OF DRAWINGS

The invention can be best understood by those having ordinary skill in the art by reference to the following detailed description when considered in conjunction with the accompanying drawings in which:

FIG. 1 is a diagram of an exemplary implementation of a full-duplex password-less authentication service, where a user requests access to services on a third-party server via a client device, and the authentication server verifies the user without the need for a password.

FIG. 2 is a diagram of the authentication process where the authentication server generates and displays a one-time password on both the third-party server and the client device for user verification, in accordance with an embodiment of the full-duplex password-less authentication service.

FIG. 3 is a diagram of a successful authentication sequence where the authentication server generates and transmits an access token to the third-party server, granting the user access to services, in accordance with an embodiment of the full-duplex password-less authentication service.

FIG. 4 is a diagram of the pre-registration process in accordance with an embodiment of the full-duplex password-less authentication service.

FIG. 5 is a diagram of an authentication sequence where the authentication server generates a one-time password displayed on the client device, allowing the user to compare and accept or decline access, in accordance with an embodiment of the full-duplex password-less authentication service.

FIG. 6 is a diagram of an example environment in which the full-duplex password-less authentication service operates, including the client device, third-party server, push notification server, authentication server, and network infrastructure.

FIG. 7 is a diagram of exemplary components of one or more devices of FIG. 6.

FIG. 8 is a flow diagram of the different steps of the registration of a user on the authentication server one-time passwords in accordance with an embodiment of the full-duplex password-less authentication service.

FIG. 9 is a flow diagram of the different steps of the authentication of a user by the authentication server one-time passwords in accordance with an embodiment of the full-duplex password-less authentication service.

FIG. 10 is a diagram of the various connections between the authentication server and the mobile device and the cryptographic key exchanges between them that provides secure access in accordance with an embodiment of the full-duplex password-less authentication service.

FIG. 11 is a diagram of the various connections between the authentication server and the third-party server and the various cryptographic key exchanges between such in accordance with an embodiment of the full-duplex password-less authentication service.

FIG. 12 is a diagram that shows all the various connections vulnerable to the man-in-the-middle attack and how such connections are protected from such an attack in accordance with an embodiment of the full-duplex password-less authentication service.

FIGS. 13-15 are diagrams of the pre-registration process in accordance with an embodiment of the full-duplex password-less authentication service.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

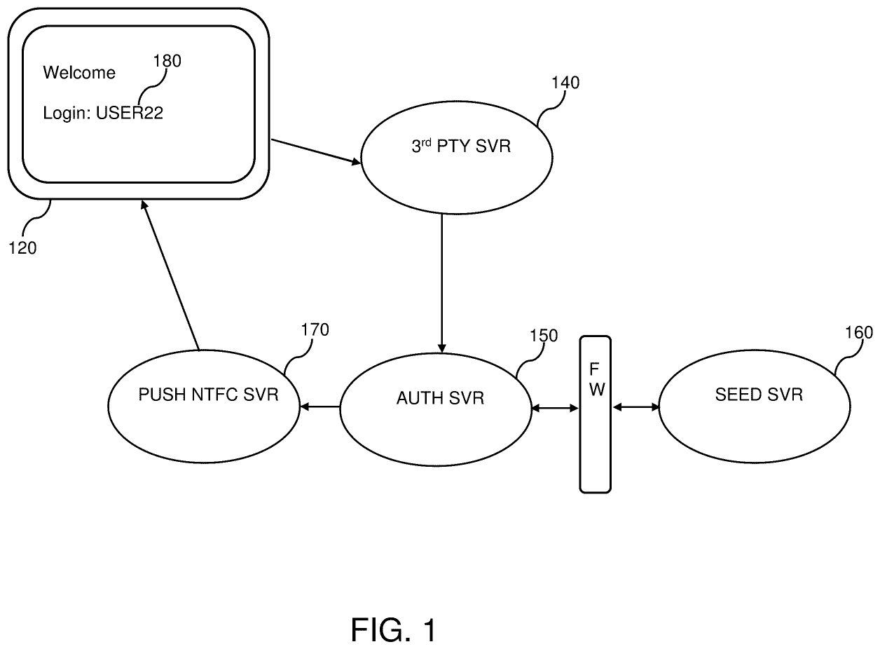

Referring to FIG. 1, a diagram of an exemplary implementation of the full-duplex password-less authentication service is described. As shown in FIG. 1, the user seeks password-less access to services (e.g., a website, a private network, a payment processing system) provided by a third-party server 140. These services are often referred to as portals or web portals, as the third-party server can host one or more such portals. The user uses a client device 120 to access the portal on the third-party server 140. The user inputs a User ID 180 (or another user identifier or username) into the client device 120, which then transmits the User ID 180 (e.g., username of “USER22”) to the third-party server 140. The third-party server 140 provides the User ID 180 to the authentication server 150. The authentication server 150 then determines an associated client device 120 of the user based on the user ID. In some embodiments, this association is made using a seed generated and stored during the pre-registration process. In some embodiments, this seed is retrieved from a seed server 160 or a secure database on the authentication server 150 or another associated server. After the client device 120 is identified by the authentication server 150, an access request is sent to the push notification server 170. The push notification server 170 uses Web-Push to send the access request to the browser on the client device 120, prompting the user to verify the request.

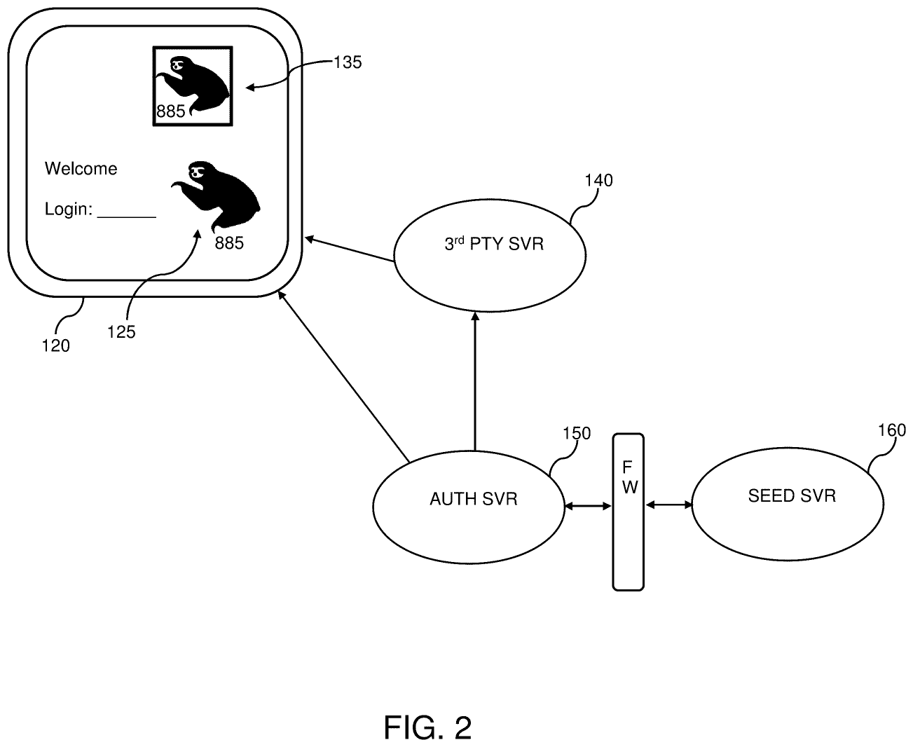

Referring to FIG. 2, a second diagram of an exemplary implementation of the full-duplex password-less authentication service is described. After the access request from the authentication server 150 is received by the browser on the client device 120, the browser displays an access request 135 for the user. This request indicates that an attempt was made to access the portal using the User ID 180 of the user previously associated with the client device 120. The access request will include an image+alphanumeric characters 135 that are generated using information from the authentication server 150 (one-time password) and data previously stored at the authentication server. After verifying the third-party server 140, the authentication server 150 generates a similar image+alphanumeric characters 125 and transmits them to the third-party server 140, where they are displayed on the client device 120. The user will compare the two sets of information and then interact with the client device 120 to accept or decline the request, allowing or denying access to the services on the third-party server 140. If the images and alphanumeric characters 125/135 match, and the user confirms, the authentication is approved; otherwise, access is denied.

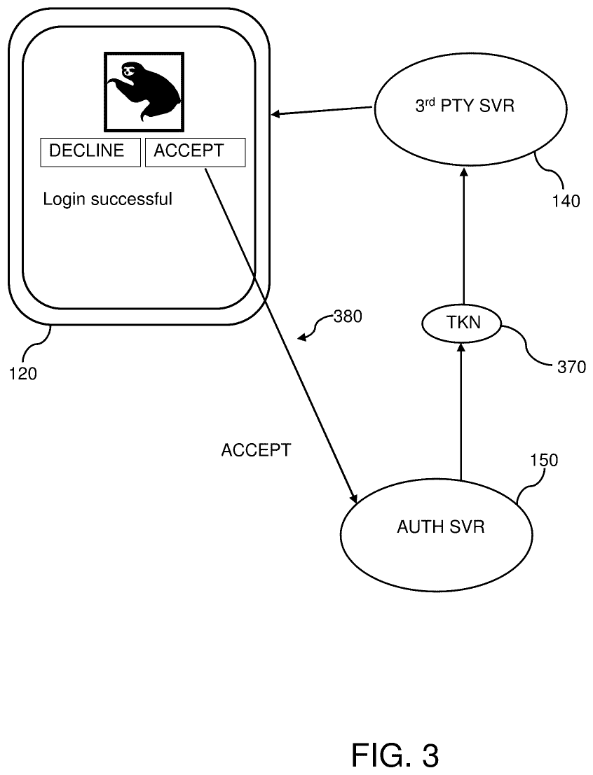

Referring to FIG. 3, a third diagram of an exemplary implementation of the full-duplex password-less authentication service is described. Assuming the user interacts with the client device 120 to allow access (accept) to the third-party server 140, the client device 120 sends the authentication server 150 an indication that the access request has been approved. The authentication server 150, after verifying the legitimacy of the approval, generates an access token 370 and transmits the access token 370 to the third-party server 140. The third-party server 140 uses the access token 370 to grant access to the client device 120 (e.g., login was successful 380), after which the allowed services/portals covered by the access token 370 are available to the user on the client device 120. This process eliminates the need for users to input passwords, ensuring a secure and seamless login experience.

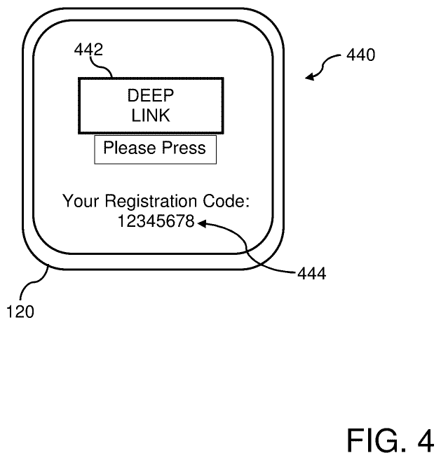

Referring to FIG. 4, a fourth diagram of an exemplary implementation of the full-duplex password-less authentication service is shown. FIG. 4 illustrates an example of user registration for the service, the user having no prior registration. In other words, this is the first time the user has requested registration. The user initiates registration from the client device 120. After requesting registration, the authentication server 150 sends a pre-registration message 440 that is displayed on the client device 120. Instead of a QR code, a Deep Link 442 containing registration information is provided. When the user clicks the Deep Link 442, the registration process is automatically completed. The Deep Link 442 directs the browser to communicate with the authentication server 150 to securely complete the registration, linking the user's credentials with the client device 120 and enabling future password-less authentication.

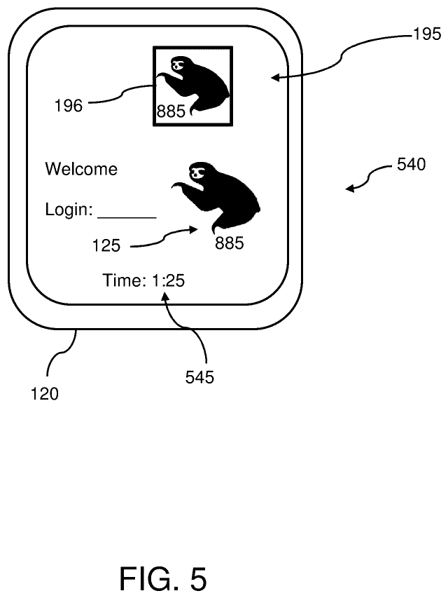

Referring to FIG. 5, a fifth diagram of an exemplary implementation relating to the processes of the full-duplex password-less authentication service is described. FIG. 5 shows an example of the password-less full-duplex authentication login scenario. The user has access to the client device 120, which is used to request access to services (e.g., a portal) provided by the third-party server 140. A login message 540 from the authentication server 150 is displayed on the client device 120. The login message contains the One-Time-Password (e.g., the similar image+alphanumeric characters 125), such as a combination of three characters or numbers as an example. This combination of an image and code comprising numbers/characters enhances the user's ability to verify what is displayed on the client device 120.

The login message contains the One-Time-Password (e.g., the similar image+alphanumeric characters 125), for example, three characters or numbers are shown as an example. The combination of image and code comprising numbers/characters improves the user's ability to compare what is viewed at the client device 120 main page and what is viewed as a pop-up 195 on the client device 120.

In some embodiments, the One-Time-Password is valid for a fixed period of time and, in such, a time counter 545 is displayed in the login message 540 that indicates the remaining time (e.g., number of minutes and/or seconds) that this One-Time-Password is valid. In such, after the time counter 545 reaches zero, the One-Time-Password will be invalidated and/or will change to a new One-Time-Password. The pop-up 195 on the client device 120 displays a one-time-password message. The one-time-password message includes the image+alphanumeric characters 196. The user has options in the One-Time-Password message 195 that is displayed on the client device 120 to accept or decline access. The user will visually compare the similar image+alphanumeric characters 125 of the login message 540 with the image+alphanumeric characters 196 of the one-time-password message and decide to accept or decline based on the sameness of the similar image+alphanumeric characters 125 compared to the image+alphanumeric characters 196.

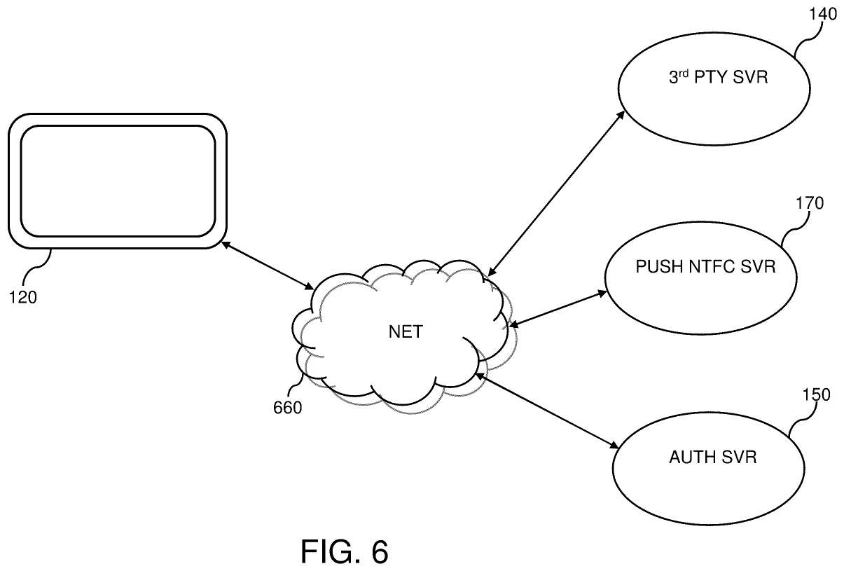

Referring to FIG. 6, a sixth diagram of an example environment in which systems and/or methods of the full-duplex password-less authentication service operate is shown. As shown in FIG. 6, the system includes a client device 120, a third-party server 140, a push notification server 170, an authentication server 150, and a network 660. The client device 120 is used by the user to access services (e.g., portals) provided by the third-party server 140, e.g., using a browser. When the user attempts to access a service via the client device 120, the third-party server 140 communicates with the authentication server 150 to initiate the authentication process.

The authentication server 150 is responsible for receiving, generating, storing, processing, and providing information associated with the full-duplex password-less authentication service. In some embodiments, the authentication server 150 authenticates both the user on the client device 120 and the third-party server 140. For example, in some embodiments, the authentication server 150 is a computing device such as a server (e.g., an authentication server, a firewall), a desktop computer, or similar hardware. The authentication server 150 is also responsible for registering one or more third-party servers 140 for the full-duplex password-less authentication service.

When the user, via the client device 120, attempts to access a service on the third-party server 140, the third-party server sends a request to the authentication server 150 to authenticate the user. The authentication server 150 sends an access request to the push notification server 170, which then uses Web-Push technology to send the access request to the browser on the client device 120. The user can interact with this prompt directly on their client device, comparing the information displayed to make a decision on whether to accept or decline the request.

In some embodiments, the client device 120 includes subsystems capable of receiving, generating, storing, processing, and/or providing information associated with the full-duplex password-less authentication service. Examples of client devices include desktop computers, laptops, tablets, handheld computers, and smartphones. A user uses the client device 120 to initiate access to third-party services, and the third-party server 140 requests that the authentication server 150 validate the user. Upon successful authentication, the authentication server 150 sends a response to the third-party server 140, which then allows the client device 120 to access the service.

The network 660 includes various wired and/or wireless networks, such as cellular networks (e.g., CDMA, LTE), local area networks (LAN), wide area networks (WAN), the Internet, and cloud computing networks. The network facilitates communication between the client device, third-party server, push notification server, and authentication server. In practice, additional networks and connections may be used, and some devices may be consolidated or distributed as needed.

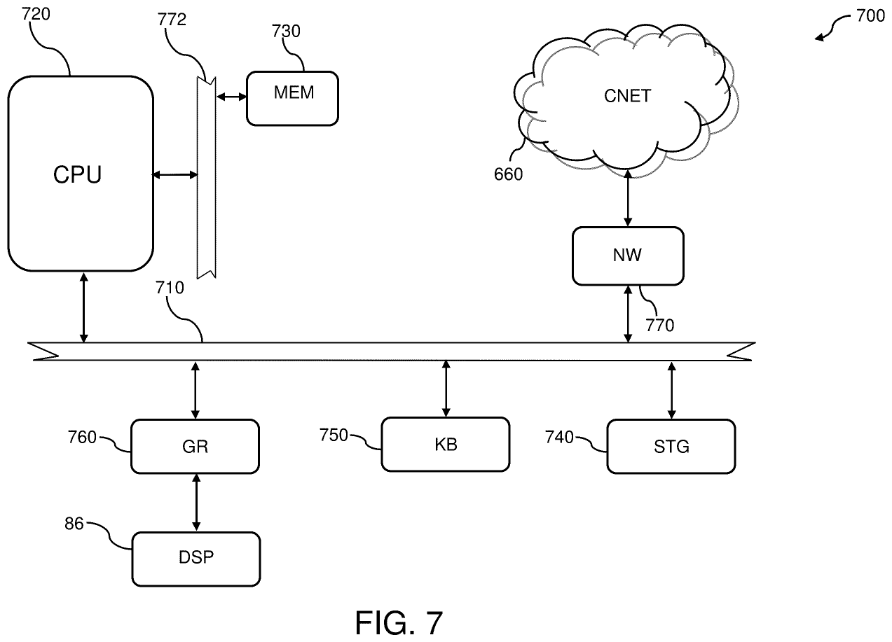

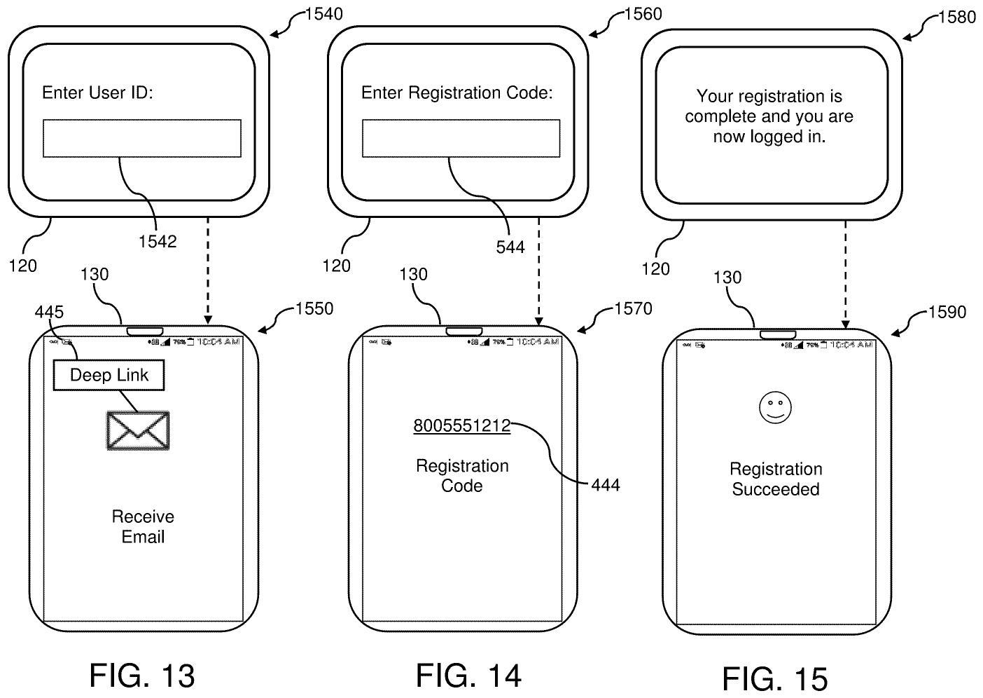

Referring to FIG. 7, a diagram of exemplary components of a device/computer/server is shown. The device 700 is anticipated to correspond to any device used as examples here within such as: the mobile device 130 (see FIG. 13), the authentication server 150 (see FIG. 1), the client device 120 (see FIG. 1), and/or the third-party server 140 (see FIG. 1). As shown in FIG. 7, the device 700 includes a bus 710, a processor 720, a memory 730 interfaced to the processor by a memory bus 772, a storage component 740, an input component 750, an output component 760, and a communication interface 770.

Bus 710 includes components that permit communication between the processor 720 and other components of device 700. The memory 730 may is any type and quantity of a random-access memory (RAM), a read only memory (ROM), and/or another type of dynamic or static storage (e.g., flash memory, optical memory) that stores information and/or instructions for use by the processor 720.

Storage component 740 stores information and/or software related to the operation and use of device 700 in a non-transitory way. For example, the storage component 740 includes a hard disk (flash memory, a magnetic memory, an optical memory, etc.), a compact disc (CD), a digital versatile disc (DVD), a floppy disc, a cartridge, a magnetic tape, and/or another type of computer-readable medium, along with a corresponding drive.

Input component 750 includes any component that permits the device 700 to receive information, such as user input (e.g., a touch screen display, a keyboard, a keypad, a mouse, a button, a switch, a microphone, etc.). Additionally, or alternatively, the input component 750 includes a sensor for sensing information (e.g., a global positioning system or GPS component, an accelerometer, a gyroscope, etc.). The output component 760 includes, for example, a component that provides output information from the device 700 (e.g., a display, a speaker, one or more light-emitting diodes (LEDs)).

The communication interface 770 includes, for example, a transceiver (e.g., a transceiver, a separate receiver and transmitter, etc.) that provides communications services for the device 700 to communicate with other devices, such as via a wired connection, a wireless connection, or a combination of wired and wireless connections. The communication interface 770 allows the device 700 to receive information from other devices and/or provide information to other devices. For example, in some embodiments, the communication interface 770 includes an Ethernet interface, a coaxial interface, an infrared interface, a radio frequency (RF) interface, a universal serial bus (USB) interface, a Wi-Fi interface, a cellular network interface, or the like.

The device 700 executes processes of the present invention in response to the processor 720 executing software instructions stored by a computer-readable medium, such as the memory 730 and/or the storage component 740. Such computer-readable medium is a non-transitory memory device. Such memory devices include memory space within a single physical storage device or memory space spread across multiple physical storage devices.

Software instructions are typically read into the memory 730 from the storage component 740 or from another computer-readable medium or from another device via the communication interface 770. When executed, software instructions stored in the memory 730 cause the processor 720 to perform one or more processes described herein. Additionally, or alternatively, hardwire circuitry may be used in place of or in combination with software instructions to perform one or more processes described herein. Thus, implementations described herein are not limited to any specific combination of hardware circuitry and software.

The sub-components of the device 700 shown in FIG. 7 are provided as an example. In practice, it is anticipated that the device 700 includes additional components, fewer components, different components, or differently arranged components than those shown in FIG. 7. Additionally, or alternatively, in some embodiments, a set of components of the device 700 performs one or more functions described as being performed by another set of components of the device 700.

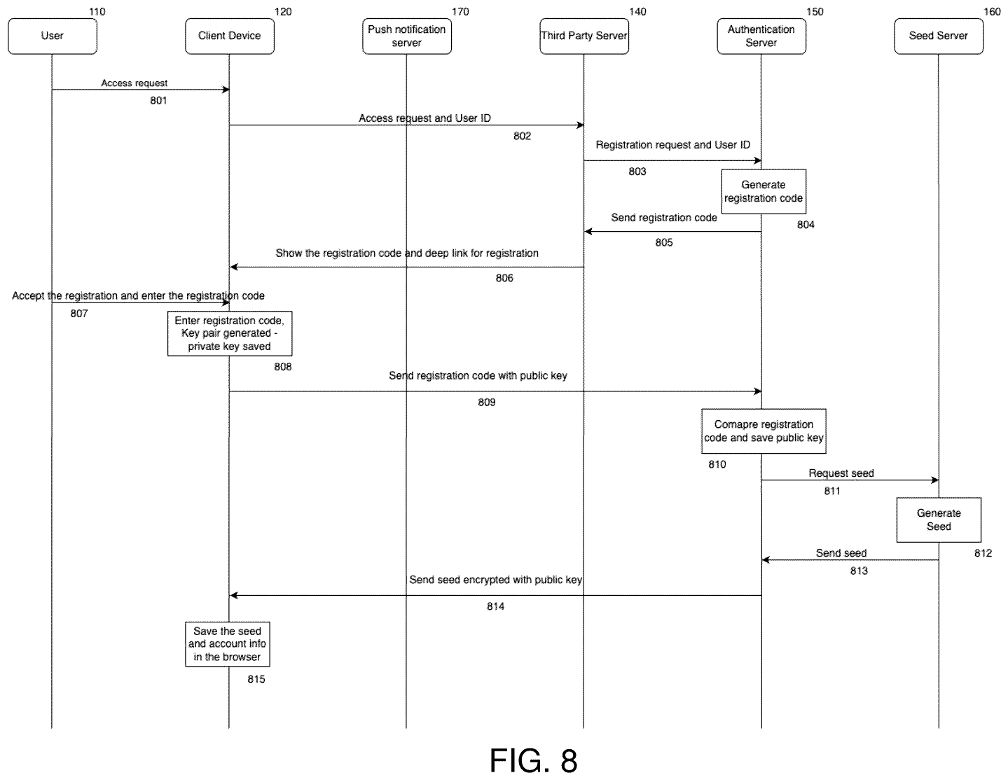

Referring to FIG. 8, a user registration process according to an embodiment of the described system in FIG. 4 is shown. A user inputs into a client device 120 the User ID 180 or/and any user credentials that were previously used to authenticate the user to the third-party server using legacy authentication (e.g., User ID 180 and password). After the user is authenticated using the third-party's legacy authentication, the user requests to be registered for full-duplex password-less authentication service using the authentication server 150, allowing the user to take advantage of the full-duplex password-less authentication method in future login attempts.

The registration request 801, along with the User ID 180 or other user identification (web cookies), is sent 802 from the client device 120 to the push notification server 170, which forwards the request to the third-party server 140. The third-party server 140 then sends 803 the registration request 801, including the user identification (User ID 180), to the authentication server 150. The authentication server 150 checks the authenticity of the third-party server 140 by verifying the server's digital certificates and ensuring that the third-party server is permitted to use the authentication server's 150 services.

After validation, the authentication server 150 generates 804 a one-time registration code for the user. This registration code is embedded in a deep link 442 (or any known encoding scheme) along with the user information and the requesting third-party server's portal. The authentication server 150 transmits 805 the one-time registration deep link and, in some cases, an installation guide (e.g., an installation link) to the third-party server 140. The third-party server 140 then sends 806 the deep link information (with the installation guide) to the client device 120. The client device 120 displays the registration deep link to the user.

The user then accepts 807 the registration info and clicks the deep link 442 on the client device 120. Once the deep link 442 is clicked, the client device generates a cryptographic key pair, storing the private key locally and sending the public key along with the registration acceptance 808 to the third-party server 140, which forwards it 809 to the authentication server 150 for comparison and verification.

The authentication server 150 compares 810 the legitimacy of the registration info and the client device web browser info. The authentication server 150 saves the user's information, including the public key received from the client device 120.

The authentication server 150 then requests 811 the seed server 160 to generate 812 a unique seed for the User ID 180. This unique seed will serve as an authentication token tied to the specific user. The seed server generates 812 the unique seed and sends it 813 to the authentication server 150. The authentication server 150 then encrypts the unique user seed with the public key and transmits it 814 to the client device 120. The client device 120 decrypts the seed and securely stores 815 the seed locally. Additionally, the registration's success or failure may be forwarded to the third-party server 140 and displayed on the client device 120 for the user.

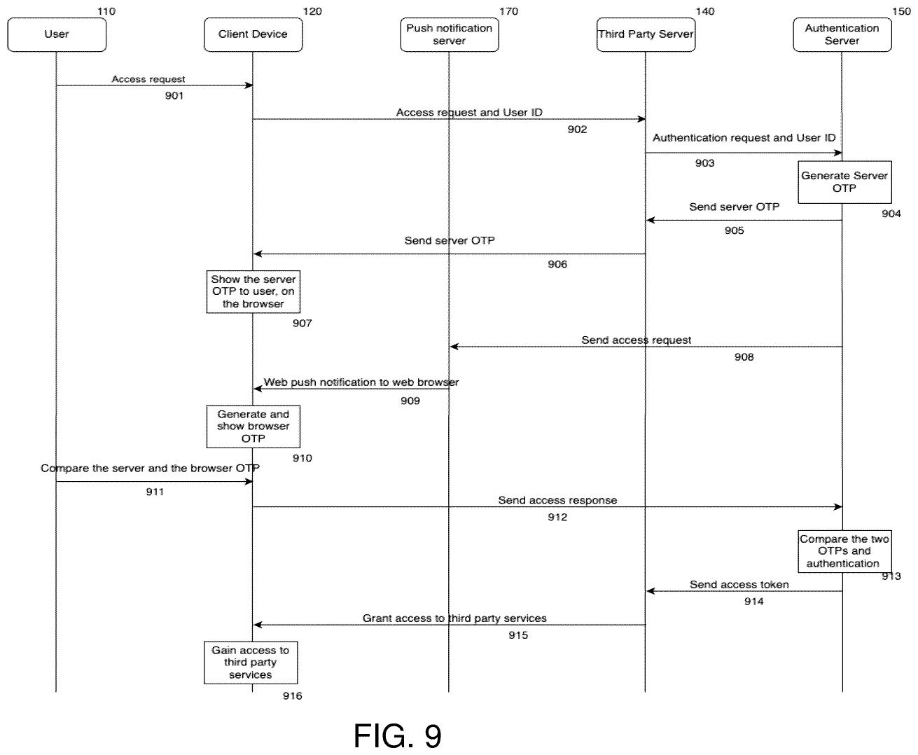

Referring to FIG. 9, a user authentication process according to one embodiment of the full-duplex password-less authentication system is shown. A user accessing a portal hosted by the third-party server 140 creates an access request 901 by inputting the User ID 180 and any other user identification that is known to the authentication server 150 into the client device 120, thereby requesting to use the full-duplex password-less authentication system. The access request 901 along with the User ID 180 is transmitted 902 to the third-party server 140 from the client device 120. The third-party server 140 transmits 903 the access request 901 with the User ID 180 to the authentication server 150.

The authentication server 150 receives the access request 901 and fetches the unique user seed associated with the User ID 180. The authentication server 150 then generates 904 a one-time password (OTP) using the unique seed and, optionally, other information received from the third-party server 140. The authentication server 150 sends 905 the server-generated OTP to the third-party server. The third-party server 140 sends 906 the server-generated OTP to the client device 120, where it is displayed 907 to the user as an alphanumeric code, which could also include a visual component for easier human comparison (such as an image+alphanumeric combination, as mentioned in other embodiments).

An access request 908 containing meta data to generate the OTP is forwarded from the Authentication Server 150 to the Push Notification Server 170, and the Push Notification Server 170 sends 909 the access request to the client device 120 (typically the user's primary browser). This triggers the client device to generate and show 910 the client device's OTP, which is displayed to the user for comparison with the server's OTP.

At this point, the user visually compares the OTPs shown on the client device 120 (browser) with the server-generated OTP. This step ensures that both OTPs match, as required for secure authentication. The user confirms 911 the match if the two OTPs are identical, acknowledging the desire to log in to the third-party server 140.

After the user confirms the match, the client device 120 sends an acceptance response 912 back to the authentication server 150 via a secure connection. The authentication server 150 then compares the two OTPs 913 to authenticate the user. If they match, the authentication server 150 generates an authentication token and sends 914 this token to the third-party server 140. In turn, the third-party server 140 grants permission and sends a transaction 915 granting such permission to the client device 120 to inform the user to access the requested third-party services. A message is displayed 916 on the client device 120, informing the user whether access was granted or denied.

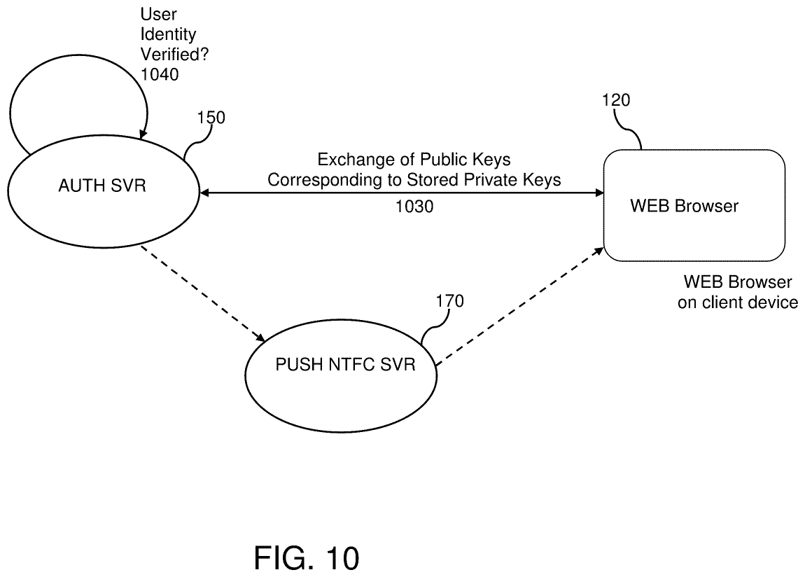

Referring to FIG. 10, a diagram of an exemplary implementation of the full-duplex password-less authentication service is described, illustrating the connection between the authentication server 150, the browser on the client device 120, and the push notification server 170, as well as the different cryptographic keys and encryption methods used between these components to communicate securely and verify the identity of the user. During the registration of the user, a set of cryptographic keys is generated and stored on the respective devices (authentication server 150 and the browser of the client device 120). A secure connection is initiated between the browser on the client device 120 and the authentication server 150, for example, using Transport Layer Security (TLS), which provides end-to-end communications security over networks. The secure connection (e.g., using TLS) starts with a handshake between the client device browser and the authentication server 150. Initially, the authentication server 150 acts as the client, and then it assumes the server role during the establishment of the secure connection; both the authentication server 150 and the browser of the client device 120 share their respective cryptographic public keys 1030 with each other.

Additionally, a set of cryptographic keys is generated on the browser of the client device 120 using, for example, the RSA 2048 algorithm. These cryptographic keys are used to encrypt messages exchanged between the client device browser and the authentication server 150. The set of cryptographic keys (private+public) is generated during the registration sequence, and the public key is sent to the authentication server 150. As mentioned, the secure connection between the client device browser and the authentication server 150 (e.g., over Transport Layer Security) ensures that data exchanged during the authentication process is secure and encrypted.

The same principles apply to the secure connection between the authentication server 150 and the push notification server 170. Additionally, a second pair of cryptographic keys is generated by the authentication server 150 using, for example, the ECDSA algorithm over the 256 curve. This second pair of cryptographic keys (private+public) is used to sign messages sent from the authentication server 150 to the push notification server 170. The public key of this second pair is sent to and stored on the push notification server 170, where it is used to verify messages signed by the private key of the second pair, which was generated and securely stored on the authentication server 150.

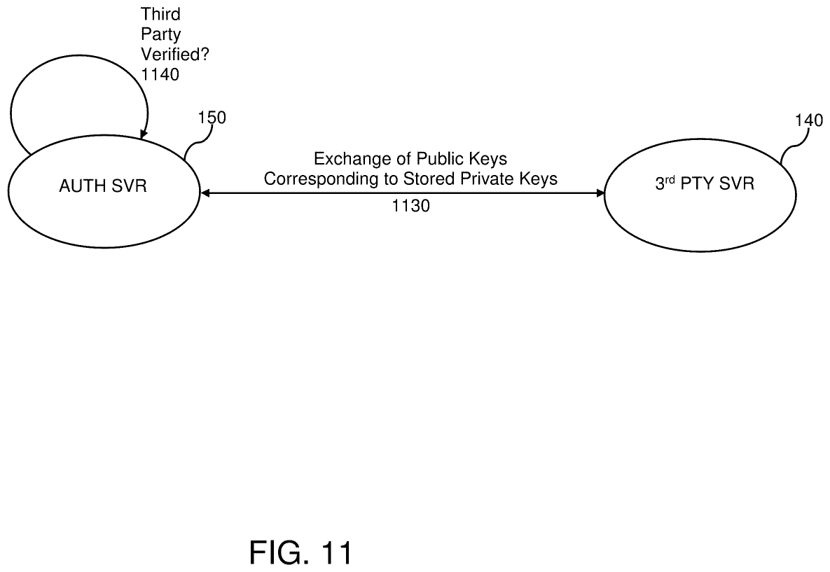

Referring to FIG. 11, a diagram of an exemplary implementation of the full-duplex password-less authentication service is described, illustrating the connection between the authentication server 150 and the third-party server 140, including the different cryptographic keys and encryption methods used to communicate safely and consequently the verification of the third-party server 140. During the registration of the third-party services by the third-party server 140 to use the service of the full-duplex password-less authentication, a secure connection is established between the authentication server 150 and the third-party server 140 (e/g/using Transport Layer Security), with the third-party server 140 initially acting as the client side and requesting the authentication server 150 to be the client. In this, the authentication server 150 forwards to the third-party server 140 the required cipher suite to establish a secure connection 1130. In some embodiments the cipher suite includes one or more of a key exchange algorithm, an authentication algorithm, an encryption algorithm, and a MAC algorithm as known in the industry. In some embodiments, the cipher suites are present in, for example, TLS versions 1.2 and TLS 1.3. In other words, the third-party server 140 requests a secure connection 1130 to the authentication server 150. In this request, the third-party server 140 discovers the methods of encryption and hashing supported by the authentication server 150 and the authentication server responds with a prioritized list of encryption methods and hashing algorithms. The third-party server 140 and authentication server 150 then agree on an encryption method and hashing algorithm and, thereafter, messages exchanged between the third-party server 140 and the authentication server 150 are encrypted and hashed based upon the agree upon encryption method and hashing algorithm for the duration of the connection.

The authentication server 150 does not communicate with third-party servers 140 that do not meet these requirements. During this connection, a pair of private and public keys is generated on both the authentication server 150 and the third-party server 140. The respective public key of each is shared with the other for future encryption. Moreover, both the authentication server 150 and the third-party server 140 will share their respective certificates that they have acquired from a valid certificate authority (CA), and those certificates are checked for authenticity by each of the authentication server 150 and the third-party server 140. After these steps have been successfully passed, the administrator that has access to the third-party server's 140 must enter a code that was given by the ownership of the authentication server 150 and the code is verified by the authentication server 150 triggering a request to verify the registration that is sent to the third-party server 140 backend that can only be interacted with by the administrator of the third-party server 140.

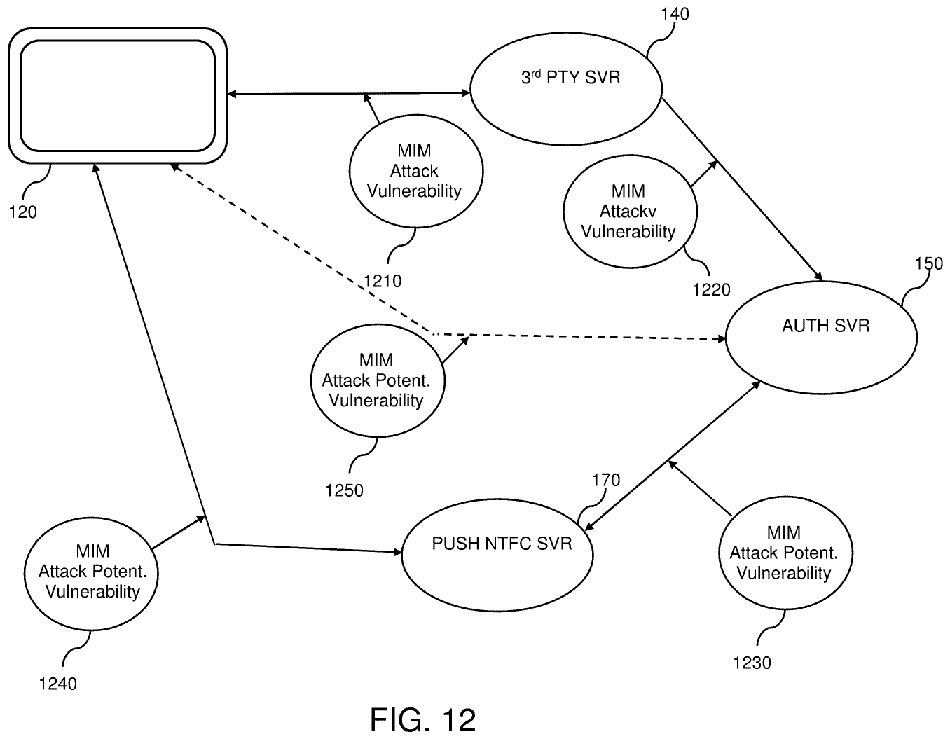

Referring to FIG. 12, a diagram of an exemplary implementation of the full-duplex password-less authentication service is shown illustrating the different connections between the involved parties and identifying potential vulnerabilities to man-in-the-middle attacks as external threats rather than inherent risks within the system. This implementation identifies potential locations for man-in-the-middle attacks and the methods used to prevent such intrusions, showcasing the robust measures that address these vulnerabilities.

A potential for a man-in-the-middle attack vulnerability 1210 exists in the communication between the client device 120 and the third-party server 140. The security of this channel relies on the client device 120, and thus, such security falls outside the scope of the full-duplex password-less authentication system but underscores the need for secure client-side configurations, such as using up-to-date browsers and avoiding unsecured networks. Another potential for a man-in-the-middle attack vulnerability 1220 is the connection between the third-party server 140 and the authentication server 150. To prevent unauthorized access, both the third-party server 140 and the authentication server 150 share and verify each other's certificates, obtained from an authorized certification authority (CA). A secure connection is established between the third-party server 140 and the authentication server 150 (e.g., using TLS), resulting in the generation of separate public and private keys on both sides of the connection. These keys are used to encrypt and decrypt all future messages between the third-party server 140 and the authentication server 150. Additionally, during the initial setup and registration of the third-party server 140 with the authentication server 150, a secret code is generated by the authentication server. This code is passed to the administrator of the third-party server 140, who inputs it into the server and retransmits it to the authentication server for verification. This secret code is only accessible by those with rightful access to the third-party server's backend, ensuring that only authorized servers can register.

The communication channel between the authentication server 150 and the client device browser provides another potential point for a man-in-the-middle attack 1250. This channel is protected by a secure connection (e.g., using TLS) between the authentication server 150 and the browser on the client device 120. Messages transmitted between the authentication server 150 and the client device browser are encrypted using the public keys of the respective parties. Additionally, the messages are signed by the private key that was generated by the client device during the setup of the full-duplex password-less authentication service. The authentication server 150 verifies these messages using the public key it received during the registration process. Furthermore, a one-time-password (OTP) is generated on the client device browser using shared static and dynamic information between the authentication server 150 and the client device browser. This OTP is sent to the authentication server 150 for verification, eliminating the possibility of intrusion on this communication channel. These safeguards highlight the system's capacity to proactively detect and prevent potential.

The next communication channel potential for a man-in-the-middle attack vulnerability 1230 is the connection between the authentication server 150 and the push notification server 170. The connection between these servers is also secured using TLS, with encrypted message transmissions facilitated by key pairs. Public keys are used to encrypt the messages exchanged between the authentication server 150 and the push notification server 170. Additionally, the authentication server 150 generates a voluntary key pair (VAPID key), which is used to cryptographically sign messages sent to the push notification server 170. The push notification server verifies these cryptographically signed messages, preventing potential man-in-the-middle attacks. The integration of VAPID keys not only enhances message authenticity but also ensures that any tampering with the communication is immediately detectable.

The communication channel between the push notification server 170 and the client device browser is also protected against man-in-the-middle attacks. This channel is secured with TLS encryption, ensuring that any push notifications sent to the client device browser remain encrypted and protected from unauthorized access. In some embodiments, an encrypted random challenge is sent by the authentication server 150, which the client device browser decrypts and retransmits to the authentication server over the secure channel. Any attempt to interfere with this communication would result in an incorrect response from the client device browser, enabling the detection of a man-in-the-middle attack. By positioning these vulnerabilities as external threats and demonstrating the system's layered defenses, the robust safeguards that underpin the security of the full-duplex password-less authentication system are clearly shown.

Referring to FIGS. 13-15, diagrams of the registration process in accordance with an embodiment of the full-duplex password-less authentication service using deep links are shown. In this process, the user 110 initiates registration from the client device 120 by entering the user identification 1542. The client device sends the user identification 1542 to the authentication server 150. The authentication server 150 generates and sends a pre-registration message 1550 to the user's email address. This pre-registration message contains a deep link 442.

The deep link 442 directs the user to continue the registration process on the client device 120 and includes an embedded one-time registration code 444 that was generated by the authentication server. Upon selecting the deep link 442, the client device 120 extracts the one-time registration code 444 and displays it (e.g., “8005551212”) in a registration message 1570 on the client device 120.

At the same time, a user interface 1560 is displayed on the client device 120, requesting that the user 110 enter the one-time registration code 444. The user 110 interacts with the client device 120 and enters the one-time registration code 444 that was displayed in the registration message 1570 into a registration code entry field 544 within the user interface 1560. The one-time registration code 444 is then sent from the client device 120 to the authentication server 150.

The authentication server 150 verifies that the one-time registration code 444 entered on the client device 120 matches the one-time registration code 444 that was embedded in the deep link 442. If the codes match, the client device 120 is successfully associated with the user ID 1542.

The authentication server 150 sends a registration success or failure message to the third-party server 140, which forwards the status to the client device 120. A registration success or failure message 1580 is then displayed on the client device 120. If successful, the third-party server 140 enables access by the user 110 through the client device 120.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A computer implemented method for full-duplex authentication of a user of a third-party server without requiring a password from the user, the computer implemented method comprising:
an authentication server sending a deep-link to a client device;
after receiving the deep-link at a browser of the client device, selecting the deep-link at the browser;
the browser receiving a user identifier of the user;
the browser sending the user identifier to the authentication server;
the authentication server generating and storing a cryptographic key pair, a public key of the cryptographic key pair stored in a storage of the authentication server that is associated with the user identifier;
the authentication server creating a secure connection to the browser of the client device and the authentication server sending a private key of the cryptographic key pair to the client device by way of the secure connection;
upon receipt of the private key at the client device, the browser saving the private key in a second storage accessible by the client device;
generating a unique seed;
the authentication server encrypting the unique seed into an encrypted unique seed using the public key;
the authentication server sending the encrypted unique seed to the client device; and
when the client device receives the encrypted unique seed from the authentication server, the browser decrypting the encrypted unique seed into the unique seed and storing the unique seed in the second storage accessible by the client device.

2. The computer implemented method of claim 1, further comprising:
the client device initiating an access request to the third-party server, the access request including the user identifier;
the third-party server transmitting the access request to the authentication server, the access request comprising the user identifier;
the authentication server retrieving the unique seed that is associated with the user identifier and the authentication server generating a one-time password using the unique seed;
the authentication server generating a visual representation of the one-time password, the visual representation comprising an image and an alphanumeric code;
upon receiving the one-time password, the browser generating a second visual representation; the second visual representation comprising a second image and a second alphanumeric code;
displaying the visual representation and the second visual representation on a display of the client device;
upon confirmation that the visual representation and the second visual representation match, the browser signing an authorization token with the private key and the browser sending the authorization token to the authentication server;
the authentication server verifying the authorization token using the public key from the storage of the authentication server that is associated with the user identifier;
when the verifying is successful, the authentication server generating an access token using the public key from the storage of the authentication server that is associated with the user identifier, the authentication server transmitting the access token to the third-party server;
responsive to receiving the access token, the third-party server granting access to the client device.

3. The computer implemented method of claim 2, wherein the unique seed is generated by requesting a seed from a seed server, the seed server responding with the unique seed.

4. The computer implemented method of claim 2, wherein the unique seed is generated by the authentication server.

5. The computer implemented method of claim 2, wherein the secure connection uses Transport Layer Security (TLS).

6. The computer implemented method of claim 2, wherein the authentication server validates the third-party server using a digital certificate from a valid certificate authority.

7. The computer implemented method of claim 2, further comprising establishing a Web-Push notification channel between the authentication server and the browser.

8. A system for full-duplex authentication of a user of a third-party server, comprising:
a client device with a browser;
a third-party server;
an authentication server;
a push notification server;
the authentication server sends a deep-link to the client device;
after receiving the deep-link at the browser of the client device, the deep-link is activated at the browser;
the browser receives a user identifier from the user;
the browser sends the user identifier to the authentication server;
the authentication server generates and stores a cryptographic key pair, a public key of the cryptographic key pair is stored in a storage of the authentication server that is associated with the user identifier;
the authentication server creates a secure connection to the browser of the client device and the authentication server sends a private key of the cryptographic key pair to the client device by way of the secure connection;
upon receipt of the private key at the client device, the browser saves the private key in a second storage accessible by the client device;
a unique seed is generated;
the authentication server encrypts the unique seed into an encrypted unique seed using the public key;
the authentication server sends the encrypted unique seed to the client device; and
when the client device receives the encrypted unique seed from the authentication server, the browser decrypts the encrypted unique seed into the unique seed and stores the unique seed in the second storage accessible by the client device.

9. The system of claim 8 further comprising:
the client device initiates an access request to the third-party server, the access request includes the user identifier;
the third-party server transmits the access request to the authentication server, the access request comprising the user identifier;
the authentication server retrieves the unique seed that is associated with the user identifier and the authentication server generates a one-time password using the unique seed;
the authentication server generates a visual representation of the one-time password, the visual representation comprising an image and an alphanumeric code;
upon receiving the one-time password, the browser generates a second visual representation; the second visual representation comprising a second image and a second alphanumeric code;
the visual representation and the second visual representation are displayed on a display of the client device;
upon confirmation that the visual representation and the second visual representation match, the browser signs an authorization token with the private key and the browser sends the authorization token to the authentication server;
after receiving the authorization token, the authentication server verifies the authorization token using the public key from the storage of the authentication server that is associated with the user identifier;
when the authorization token verifies, the authentication server generates an access token using the public key from the storage of the authentication server that is associated with the user identifier, the authentication server transmits the access token to the third-party server;
responsive to receiving the access token, the third-party server grants access to the client device.

10. The system of claim 9, wherein the one-time password is valid for a fixed period of time indicated by a time counter displayed in the browser.

11. The system of claim 9, wherein the authentication server and the third-party server share and verify each other's certificates from a valid certificate authority.

12. The system of claim 9, wherein when the authentication server generates the visual representation of the one-time password, the visual representation comprising the image and the alphanumeric code is sent to the browser using the push notification server, the push notification server uses Web-Push to send notifications to the browser.

13. The system of claim 9, wherein cryptographic keys are shared between the authentication server and the third-party server.

14. The system of claim 9, wherein the authentication server validates connections using cipher suites from TLS versions 1.2 and TLS 1.3.

15. A method for full-duplex authentication of a user of a third-party server without requiring a password from the user, the method comprising:
an authentication server sending a deep-link to a client device;
after receiving the deep-link at a browser of the client device, selecting the deep-link at the browser;
the browser receiving a user identifier of the user;
the browser sending the user identifier to the authentication server;
the authentication server generating and storing a cryptographic key pair, a public key of the cryptographic key pair stored in a storage of the authentication server that is associated with the user identifier;
the authentication server creating a secure connection to the browser of the client device and the authentication server sending a private key of the cryptographic key pair to the client device by way of the secure connection;
upon receipt of the private key at the client device, the browser saving the private key in a second storage accessible by the client device;
generating a unique seed;
the authentication server encrypting the unique seed into an encrypted unique seed using the public key;
the authentication server sending the encrypted unique seed to the client device; and
when the client device receives the encrypted unique seed from the authentication server, the browser decrypting the encrypted unique seed into the unique seed and storing the unique seed in the second storage accessible by the client device.

16. The method of claim 15, further comprising:
the client device initiating an access request to the third-party server, the access request including the user identifier;
the third-party server transmitting the access request to the authentication server, the access request comprising the user identifier;
the authentication server retrieving the unique seed that is associated with the user identifier and the authentication server generating a one-time password using the unique seed;
the authentication server generating a visual representation of the one-time password, the visual representation comprising an image and an alphanumeric code;
upon receiving the one-time password, the browser generating a second visual representation; the second visual representation comprising a second image and a second alphanumeric code;
displaying the visual representation and the second visual representation on a display of the client device;
upon confirmation that the visual representation and the second visual representation match, the browser signing an authorization token with the private key and the browser sending the authorization token to the authentication server;
the authentication server verifying the authorization token using the public key from the storage of the authentication server that is associated with the user identifier;
when the verifying is successful, the authentication server generating an access token using the public key from the storage of the authentication server that is associated with the user identifier, the authentication server transmitting the access token to the third-party server;
responsive to receiving the access token, the third-party server granting access to the client device.

17. The method of claim 16, wherein the second visual representation comprises one image selected from one thousand stored images combined with three characters.

18. The method of claim 16, wherein the one-time password is valid for a fixed time period shown by a countdown field displayed by the browser.

19. The method of claim 16, wherein the authentication server connects to the browser through an encrypted channel.

20. The method of claim 16, wherein a connection between the third-party server and the authentication server is secured using a TLS cipher suite.
